(19) United States
(12) Patent Application Publication
(10) Pub. No.: US 2007/0071509 A1
(43) Pub. Date: Mar. 29, 2007

(54) Electrophotographic image forming apparatus

(75) Inventors: Byeong-hwa Ahn, Seongnam-si (KR); Se-hyun Lyu, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/511,362

(22) Filed: Aug. 29, 2006

(30) Foreign Application Priority Data
Sep. 26, 2005 (KR) 10-2005-0089505

(51) Int. Cl. G03G 15/01; G03G 15/16

(52) U.S. Cl. 399/299; 399/313

(57) ABSTRACT

An electrophotographic image forming apparatus for enhancing color registration is provided. The electrophotographic image forming apparatus includes a developing unit including a photosensitive medium, an image transferring device, and a paper feeding device. The image transferring device includes a pair of conveying rollers, a conveying belt, and a plurality of transfer rollers. The conveying belt is supported by the conveying rollers and rotates around the conveying rollers and conveys a recording medium by attaching a recording medium to a surface thereof. The plurality of transfer rollers are disposed inside the conveying belt and form a transfer nip between the recording medium and the photosensitive medium. The paper feeding device provides the recording medium to the image transferring device. The force of the image transferring device that maintains the position of the recording medium with respect to the conveying belt during image transferring is equal to or greater than the maximum force applied to the recording medium by the paper feeding device.

### CROSS-REFERENCE TO RELATED PATENT APPLICATIONS

This application claims the benefit under 35 U.S.C. § 119(a) of Korean Patent Application No. 10-2005-0089505, filed on Sep. 26, 2005 in the Korean Intellectual Property Office, the entire disclosure of which is hereby incorporated by reference.

### BACKGROUND OF THE INVENTION

1. Field of the Invention

The present invention relates to an electrophotographic image forming apparatus. More particularly, the present invention relates to an electrophotographic image forming apparatus which enhances the transfer quality of a toner image transferred from a photosensitive medium to a sheet of paper.

2. Description of the Related Art

An electrophotographic image forming apparatus produces an image by scanning light corresponding to a desired image onto a photosensitive medium charged to a uniform electrostatic potential, thereby forming an electrostatic latent image. The electrostatic latent image is developed into a visible image by applying a developer, such as toner, onto the electrostatic latent image. The developed image is then transferred from the photosensitive medium onto a sheet of paper, and the transferred image is fused onto the paper.

An image forming apparatus which produces a color image develops yellow, magenta, cyan, and black images using developer cartridges containing yellow, magenta, cyan, and black developers, respectively. The developed color images are superimposed upon each other to form a full-color image. A color image forming apparatus may include a plurality of developer cartridges that share a single photosensitive medium or a plurality of developer cartridges that include individual photosensitive media.

In a conventional electrophotographic image forming apparatus, the recording medium is supplied by a paper feeding device. While an image is being transferred onto a leading portion of a recording medium, a trailing portion of the recording medium is affected by the paper feeding device. This may cause slip between the photosensitive media and the recording medium.

When a developed image is transferred onto the recording medium, the recording medium is firmly pressed against each photosensitive medium by transfer rollers which correspond to the developer cartridges. In this case, when the first developed color is transferred (typically, the yellow developer), the friction force between the conveying device, the photosensitive media and the recording medium is relatively small. Because there is little friction force, the force applied by the paper feeding device to the recording medium may cause an increased color registration error.

Accordingly, there is a need for an improved image forming apparatus which minimizes color registration errors caused by the paper feeding device.

### SUMMARY OF THE INVENTION

The present invention relates to a color image forming apparatus including a plurality of developer cartridges which each include a photosensitive media. The color image forming apparatus includes a conveying device which is installed opposite to each of the photosensitive media included in the developer cartridges, and forms a color image by transferring toner from the developer cartridges onto a desired image on a recording medium, for example, a sheet of paper, in a superimposed manner while the conveying device is conveying the recording medium. A paper feeding device is installed in front of the conveying device to feed the recording medium to the conveying device.

When a color image is formed, the developers of four colors should overlap with each other at a precise location, that is, there should be precise color registration. Therefore, the recording medium conveying speed and the times that developer is transferred from each developer cartridge are accurately controlled. Furthermore, slip is minimized while a recording medium is conveyed by a plurality of developer cartridges.

An aspect of the present invention is to provide an electrophotographic image forming apparatus which provides accurate color registration of a print image by preventing a recording medium from being moved by a paper feeding device while a color image is transferred to the recording medium.

According to an aspect of the present invention, an electrophotographic image forming apparatus comprises a developing unit including a photosensitive medium, an image transferring device and a paper feeding device. The image transferring device comprises a pair of conveying rollers, a conveying belt, and a plurality of transfer rollers. The conveying belt is supported by the conveying rollers, rotates around the conveying rollers, and conveys a recording medium by attaching the recording medium to a surface thereof. The plurality of transfer rollers are disposed inside the conveying belt, and form transfer nips with the photosensitive medium. The paper feeding device provides the recording medium to the image transferring device. The force of the image transferring device that maintains a position of the recording medium with respect to the conveying belt during image transferring is equal to or greater than the maximum force applied to the recording medium by the paper feeding device.

The force of the image transferring device that maintains the position of the recording medium with respect to the conveying belt and the force applied to the recording medium from the paper feeding roller are friction forces. The direction of the friction force is opposite to a sliding direction of the printing medium, and the maximum static friction force is calculated by multiplying a normal force and a friction coefficient. Thus, the maximum static friction can be easily controlled by controlling the normal forces of rollers pressing the recording medium, such as a paper charging roller, transfer rollers, and feeding rollers.

The feeding device generally picks up a recording medium which is stacked in a feeding cassette, that is, a sheet of paper, and feeds the paper to the image transferring device. According to an embodiment of the present invention, the feeding device is feeding rollers that convey the paper to the image transferring device. The feeding rollers may affect the printing medium during image transferring. The present invention is not limited to feeding rollers, however, and encompasses other paper feeding devices that feed a printing medium and affect the recording medium during image transfer.

When the recording medium is provided to the image transferring device, the conveying belt and the paper charging roller receive the recording medium. A toner image starts to be transferred to the recording medium at about the time when a leading end of the recording medium, which is attached to the conveying belt by electrostatic forces, arrives at a transfer nip formed by a photosensitive medium and the conveying belt. At this time, a trailing end of the printing medium is affected by the feeding device.

In the electrophotographic image forming apparatus, the force applied to the printing medium from the feeding device during image transferring is smaller than a force conveying the printing medium while attaching the printing medium to the conveying belt. In other words, the force that maintains the position of the printing medium with respect to the conveying belt is equal to or larger than the force applied to the printing medium from the feeding device during image transferring. Thus, color registration is improved.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a cross-sectional view of an electrophotographic image forming apparatus according to an exemplary embodiment of the present invention;

FIG. 2 illustrates an image transferring device and a paper feeding device according to an exemplary embodiment of the present invention;

FIG. 3 is a detailed view of a recording medium entering portion of an image transferring device according to an exemplary embodiment of the present invention;

FIG. 4 illustrates friction forces applied to a recording medium when a feeding roller travels at low speed;

FIG. 5 illustrates friction forces applied to the recording medium when the feeding roller travels at high speed;

FIG. 6 illustrates color registration errors in a conventional electrophotographic image forming apparatus; and

FIG. 7 illustrates color registration errors in an electrophotographic image forming apparatus according to an exemplary embodiment of the present invention.

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention and are merely exemplary. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

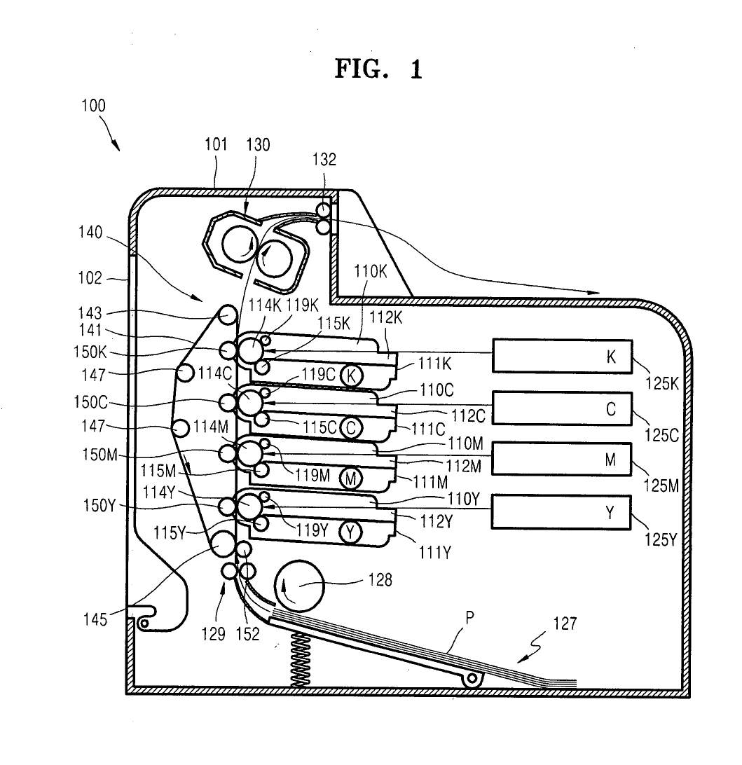

FIG. 1 is a cross-sectional view of an electrophotographic image forming apparatus 100 according to an exemplary embodiment of the present invention. Referring to FIG. 1, the electrophotographic image forming apparatus 100 is a tandem type image forming apparatus in which visible images of different colors are sequentially transferred to a sheet of paper P and superimposed upon each other to form a full-color image on the paper P. The electrophotographic image forming apparatus 100 includes a case 101 in which an image transferring device 140, a paper feeding device for feeding the paper P to the image transferring device 140, a fuser 130, and discharge rollers 132 for discharging the paper P on which an image has been printed to the outside of the case 101 are included. The image transferring device 140 includes four developing units 110Y, 110M, 110C, and 110K, four light scanners 125Y, 125M, 125C, and 125K, and a conveying belt 141. The paper feeding device includes a paper feeding cassette 127 for holding sheets of paper P, a pickup roller 128 for picking up a sheet of paper P from the paper feeding cassette 127, and feeding rollers 129 for conveying the picked up paper P.

The developing units 110Y, 110M, 110C, and 110K are cartridge type developing units which may be replaced with new ones when developer, such as toner, stored therein is exhausted. In the present exemplary embodiment, the four developing units 110Y, 110M, 110C, and 110K contain yellow, magenta, cyan, and black toners, respectively.

The image transferring device 140 is laterally arranged with respect to the door 102 and the developing units 110Y, 110M, 110C, and 110K may be replaced by opening a door 102 formed on a side of the case 101.

In the present exemplary embodiment, the four light scanners 125Y, 125M, 125C, and 125K correspond to the four developing units 110Y, 110M, 110C, and 110K, respectively. Each of the light scanners 125Y, 125M, 125C, and 125K scans light corresponding to image information of yellow, magenta, cyan, and black colors to photosensitive media 114Y, 114M, 114C, and 114K which are included in housings 111Y, 111M, 111C, and 111K, respectively. The light scanners 125Y, 125M, 125C, and 125K may be laser scanning units (LSUs) that use a laser diode as a light source.

The developing units 110Y, 110M, 110C, and 110K include housings 111Y, 111M, 111C, and 111K, respectively. The housings 111Y, 111M, 111C, and 111K include photosensitive media 114Y, 114M, 114C, and 114K and developing rollers 115Y, 115M, 115C, and 115K, respectively. The portion of each of the photosensitive media 114Y, 114M, 114C, and 114K that is located opposite to the conveying belt 141 while printing an image is exposed to the outside of the housings 111Y, 111M, 111C, and 111K so that the image may be transferred. Furthermore, the developing units 110Y, 110M, 110C, and 110K include discharging rollers 119Y, 119M, 119C, and 119K, respectively. A charge bias voltage is applied to the discharge rollers 119Y, 119M, 119C, and 119K to charge the outer circumferential surface of each of the photosensitive media 114Y, 114M, 114C, and 114K to a uniform electrostatic potential.

Toner is attached to the outer circumferential surfaces of the developing rollers 115Y, 115M, 115C, and 115K and then provided to the photosensitive media 114Y, 114M, 114C, and 114K. A developing bias voltage is applied to the developing rollers 115Y, 115M, 115C, and 115K to supply the toner to the photosensitive media 114Y, 114M, 114C, and 114K. The housings 111Y, 111M, 111C, and 111K contain supply rollers (not illustrated) that provide toner to the developing rollers 115Y, 115M, 115C, and 115K, doctor blades (not illustrated) that regulate the amount of toner attached to the developing rollers 115Y, 115M, 115C, and 115K, and agitators (not illustrated) that agitate the toner contained in the housings 111Y, 111M, 111C, and 111K for supplying toner to the supply roller and preventing the toner from hardening. In the present exemplary embodiment, each of the developing units 110Y, 110M, 110C, and 110K respectively includes an opening 112Y, 112M, 112C, and 112K that forms a path for allowing light to be scanned from the light scanning units 125Y, 125M, 125C, and 125K onto the photosensitive media 114Y, 114M, 114C, and 114K.

The image transferring device 140 includes a first conveying roller 143, a second conveying roller 145, a conveying belt 141, four transfer rollers 150Y, 150M, 150C, and 150K and auxiliary supporting rollers 147. The first conveying roller 143 is a driving roller, and the second conveying roller 145 is an idle roller. The second conveying roller is disposed under the first conveying roller 143. The conveying belt 141 is supported by the first and second conveying rollers 143 and 145 and rotates around the first and second conveying rollers 143 and 145. Auxiliary supporting rollers 147 also support the conveying belt 141. The four transfer rollers 150Y, 150M, 150C, and 150K are arranged between the first and second conveying rollers 143 and 145, and are arranged opposite to the four photosensitive media 114Y, 114M, 114C, and 114K, respectively, so that the conveying belt 141 is interposed therebetween. A transfer bias voltage is applied to the transfer rollers 150Y, 150M, 150C, and 150K.

When the four transfer rollers 150Y, 150M, 150C, and 150K are elastically pressed to the conveying belt 141, a transfer nip is formed between the transfer rollers 150Y, 150M, 150C, and 150K and the photosensitive medium. Also, a normal force that produces friction between the paper P, the conveying belt 141 and the photosensitive medium is generated. The normal force may be generated by an elastic member (not shown) that presses a shaft of the transfer roller. Preferably, the normal force is the same intensity for the four transfer rollers 150Y, 150M, 150C, and 150K.

The image transferring device 140 includes a paper charging roller 152 disposed opposite to the second conveying roller 145. The conveying belt 141 is interposed between the paper charging roller 152 and the second conveying roller 145. The paper charging roller 152 charges the paper P, which is picked up from the paper feeding cassette 127 and upwardly conveyed, by electrostatic induction so that the paper P is attached to a surface of the conveying belt 141. When the paper charging roller 152 is elastically pressed to the conveying belt 141, the force of the paper charging roller 152 pressing the paper P acts as a normal force that causes friction, thereby maintaining the position of the paper P with respect to the conveying belt 141. Therefore, the maximum static fiction force between the paper P and the paper charging roller 152 can be easily controlled by controlling the elastic force of the elastic member that presses the paper charging roller 152 toward the conveying belt 141.

An example of a process of forming a color image with the electrophotographic image forming apparatus described above will now be described.

A charge bias voltage is applied to each of the photosensitive media 114Y, 114M, 114C, and 114K to charge the photosensitive media 114Y, 114M, 114C, and 114K to a uniform electrostatic potential. The light scanners 125Y, 125M, 125C, and 125K scan light corresponding to yellow, magenta, cyan, and black images to the photosensitive media 114Y, 114M, 114C, and 114K through the openings 112Y, 112M, 112C, and 112K, respectively. Thus, an electrostatic latent image is formed on the outer circumferential surface of each of the photosensitive media 114Y, 114M, 114C, and 114K. When a developing bias voltage is applied to the developing rollers 115Y, 115M, 115C, and 115K, the toner is transferred from the developing rollers 115Y, 115M, 115C, and 115K onto the outer circumferential surfaces of the photosensitive media 114Y, 114M, 114C, and 114K so that visible yellow, magenta, cyan, and black toner images are formed on the outer circumferential surfaces of the photosensitive media 114Y, 114M, 114C, and 114K, respectively.

The paper P is picked up from the paper feeding cassette 127 by the pickup roller 128, and fed by the feeding rollers 129. When a predetermined voltage is applied to the paper charging roller 152, the upwardly conveyed paper P is charged by electrostatic induction, then attached to a surface of the conveying belt 141, and conveyed at the same speed as the speed of the conveying belt 141. A leading end of the paper P attached to and conveyed by the conveying belt 141 arrives at a transfer nip formed between the opposing transfer roller 150Y and conveying belt 141 at about the time when a leading end of a yellow visible toner image formed on the circumferential surface of the undermost photosensitive medium 114Y arrives at the transfer nip. At this moment, when a transfer bias voltage is applied to the transfer roller 150Y, the toner image formed on the photosensitive medium 114Y is transferred to the paper P. As the paper P is continuously moved, magenta, cyan, and black toner images formed on the other photosensitive media 114M, 114C, and 114K are sequentially transferred to the paper P so that they are superimposed upon each other to form a full-color image on the paper P. The fuser 130 fuses the image on the paper P by applying heat and pressure. The paper P with the completely fused image is discharged outside the case 101 by the discharging roller 132.

According to the exemplary embodiment of the present invention, the electrophotographic image forming apparatus 100 maintains the speed of the paper P so that it is the same as the speed of the conveying belt 141. This prevents the paper P from being affected by the feeding rollers 129 which retain a trailing end of the paper P even when a leading end of the paper P is held in the first transfer nip. Therefore, a color registration error due to the feeding roller 129 can be avoided.

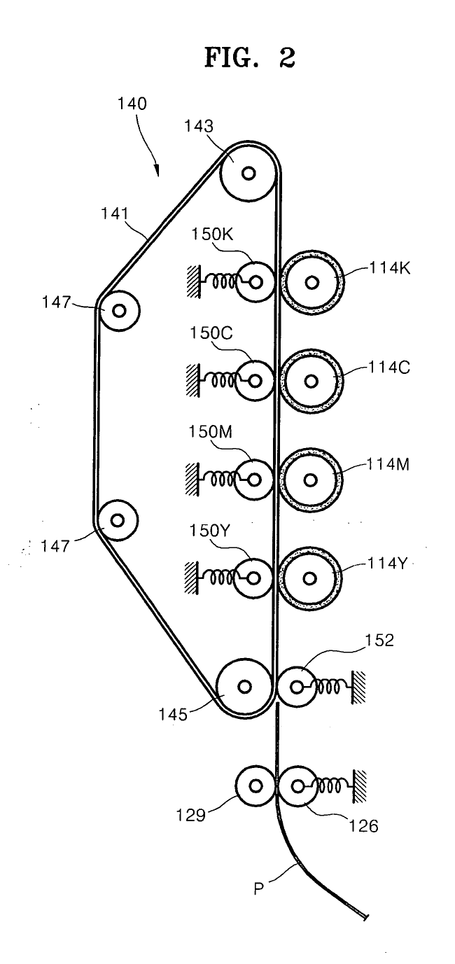

FIG. 2 illustrates an image transferring device 140 and a paper feeding device according to an exemplary embodiment of the present invention. In the present exemplary embodiment, the four transfer rollers 150Y, 150M, 150C, and 150K are elastically pressed toward the four opposite photosensitive media 114Y, 114M, 114C, and 114K. The conveying belt 141 is interposed between the transfer rollers 150Y, 150M, 150C, and 150K and the photosensitive media 114Y, 114M, 114C, and 114K. A sheet of paper P is attached to an outer surface of the conveying belt 141 and is conveyed by the conveying belt 141. The four transfer rollers 150Y, 150M, 150C, and 150K are preferably pressed with approximately the same force.

The paper charging roller 152 is disposed in a portion of the image transferring device 140 where the paper P is fed into the image transferring device 140. The paper charging roller 152 is disposed opposite to the second conveying roller 145 and the conveying belt 141 is interposed therebetween. The shaft of the paper charging roller 152 is elastically pressed toward the conveying belt 141.

A pair of feeding rollers 129 and 126 are installed in front of the image transferring device 140. More specifically, the feeding roller 129 is a driving roller and the roller 126 is a pressing roller. The pressing roller 126 is elastically pressed toward the feeding driving roller 129, and conveys the paper P while rotating in contact with the feeding driving roller 129. The paper P is conveyed due to friction between the pressing roller 126, feeding driving roller 129 and paper P, and the maximum force applied by the pair of the feeding rollers 129 and 126 is the maximum static friction force.

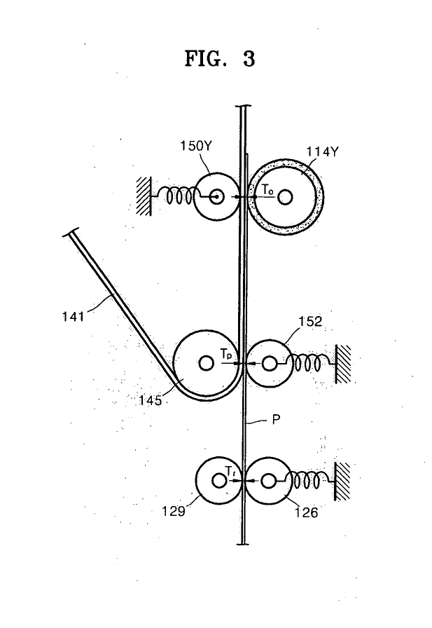

FIG. 3 is a detailed view of a recording medium entering portion of an image transferring device according to an exemplary embodiment of the present invention. In FIG. 3, the sheet of paper P is fed by the feeding roller 129, passes by the paper charging roller 152, and then arrives at the first transfer nip. The first transfer nip is formed by the photosensitive medium 114Y on which a yellow image is developed and the transfer roller 150Y.

Thus, when a leading end of the paper P arrives at the first transfer nip and the yellow image is transferred to the paper P, the paper is subjected to a force Tₒ, which is perpendicular to the direction that the paper travels from the transfer roller 150Y and photosensitive medium 114Y, a force T_{P}, which is perpendicular to the direction that the paper travels from the paper charging roller 152 and second conveying roller 145, and a force Tᵣ, which is perpendicular to the direction that the paper travels from the feeding roller 129 and press roller 126. The forces applied to the paper P from the opposing rollers are action and reaction forces that compensate each other. Hence, the same normal forces are applied to both sides of the paper P.

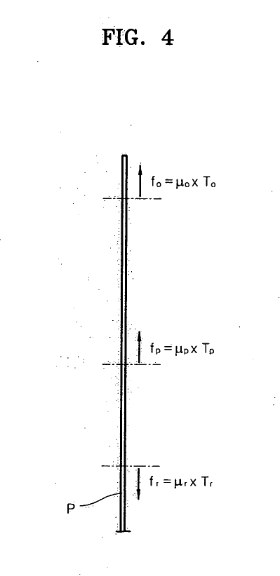

FIG. 4 illustrates friction forces applied to a recording medium when a feeding roller travels at low speed. Since the same normal forces are applied to both sides of the paper P when the paper P is pressed, the maximum static friction force fₒ applied to the paper P in the first transfer nip can be calculated by multiplying the friction coefficient μₒ and a normal force Tₒ. The friction coefficient μₒ is obtained by adding the friction coefficient between the photosensitive medium and the paper to the friction coefficient between the paper and the conveying belt. In the same fashion, the maximum static friction force fₚ generated by the paper charging roller is calculated by multiplying the friction coefficient μₚ and a normal force Tₚ. The friction coefficient μₚ is obtained by adding the friction coefficient between the paper charging roller and the paper to the friction coefficient between the paper and the conveying belt. Moreover, the maximum static friction force fᵣ generated by the feeding roller is calculated by multiplying a friction coefficient μᵣ and a normal force Tᵣ. The friction coefficient μᵣ is obtained by adding the friction coefficient between the feeding roller and the paper and the friction coefficient between the press roller and the paper. The above friction coefficients are the maximum static friction coefficients.

When the linear speed of the feeding roller is slower than the conveying speed of the conveying belt, the friction forces fₒ and fₚ generated by the transfer roller and the paper charging roller are applied to the paper in a paper traveling direction, while the friction force fᵣ generated by the feeding roller is applied to the paper in a direction opposite to the paper traveling direction. According to the exemplary embodiment of the present invention, in this case, the sum of the maximum static friction force fₒ generated by the transfer roller and the maximum static friction force fₚ generated by the paper charging roller is greater than the maximum static friction force fᵣ generated by the feeding roller. Hence, even when the linear speed of the feeding roller is slower than the speed of the conveying belt, slippage between the paper and the photosensitive medium in a transfer nip does not occur, and slippage between the feeding roller and the paper occurs earlier. That is, color registration is not affected.

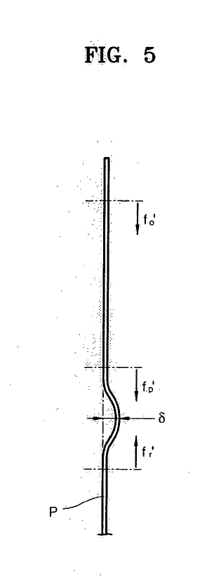

FIG. 5 illustrates a friction force applied to the recording medium when the feeding roller travels at high speed. When the linear speed of the feeding roller is faster than the speed of the conveying belt, the paper is curled between a nip at the feeding roller and a nip at the paper charging roller. When a restoring force corresponding to a variation of the paper is applied to both surfaces of the curled portion of the paper, a friction force is generated in the direction illustrated with an arrow in FIG. 5. Since a recording medium, such as paper, typically used for an electrophotographic image forming apparatus is thin and flexible, the restoring force generated by the curling is much smaller than the maximum static friction forces at the transfer roller, feeding roller, and paper charging roller, and a maximum static friction force between the conveying belt and the recording medium. Therefore, the curling of the paper does not need to be taken into consideration when the pressing forces of the above rollers are determined.

Even when the recording medium has a high stiffness, slippage in the transfer nip can be prevented when the sum of the maximum static friction forces fₒ′ and fₚ′ is greater than the maximum static friction force fᵣ′ at the feeding roller.

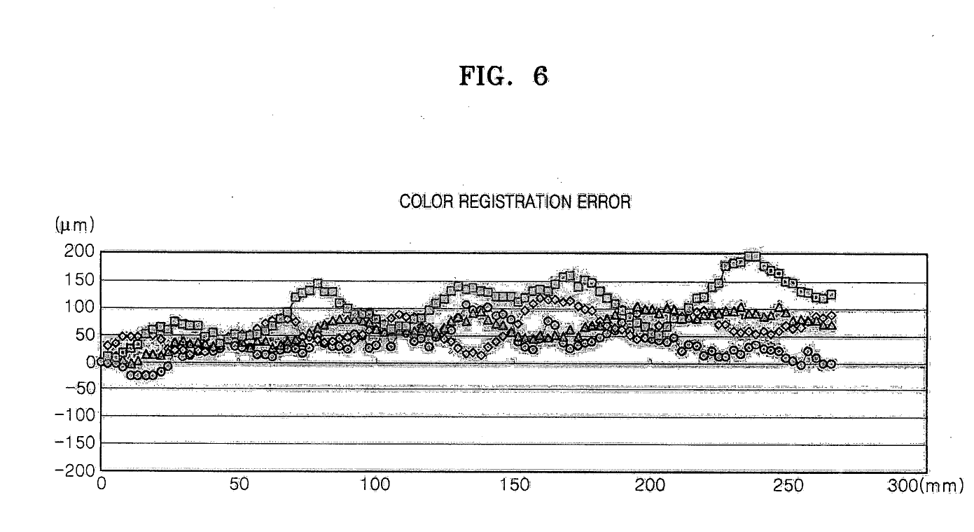

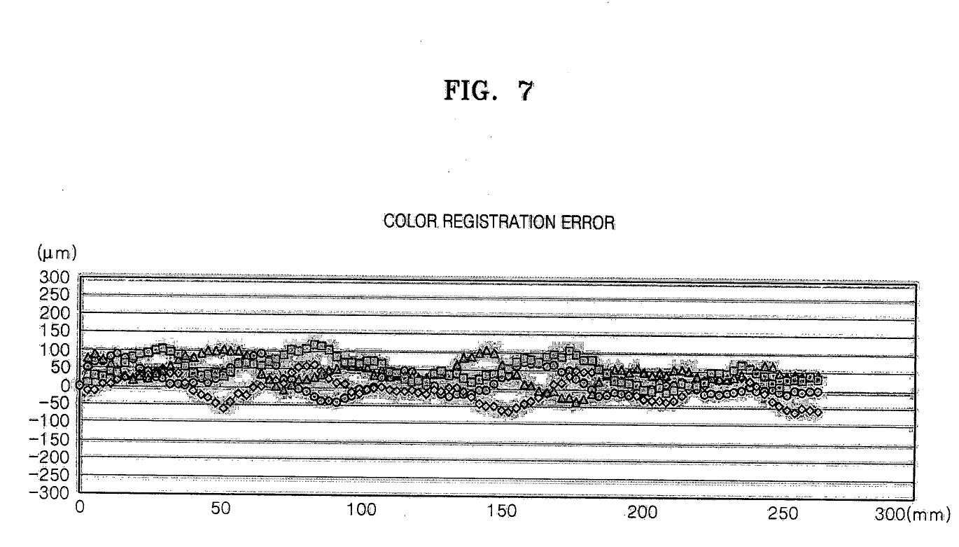

FIG. 6 illustrates color registration errors in a conventional electrophotographic image forming apparatus, and FIG. 7 illustrates color registration errors in an electrophotographic image forming apparatus according to an exemplary embodiment of the present invention. The horizontal axis represents the position of an image on the paper, and the vertical axis represents the registration error of each color at the image position.

In FIGS. 6 and 7, □ denotes yellow color registration error, Δ denotes magenta color registration error, ⋄ denotes cyan color registration error, and ◯ denotes black color registration error. Referring to FIG. 6, in a conventional image forming apparatus, yellow color registration error is large, and each of the other color registration errors become increasingly larger towards the trailing portion of the paper. On the other hand, referring to FIG. 7, in an electrophotographic image forming apparatus according to an exemplary embodiment of the present invention, the color registration errors of all four colors are not large, and the appearances of errors are similar to each other.

According to the exemplary embodiment of the present invention, an electrophotographic image forming apparatus minimizes the possibility of a recording medium from being moved by a paper feeding device, and thus produces more precise color registration of a print image.

While the invention has been shown and described with reference to certain exemplary embodiments thereof, it will be understood by those skilled in the art that various changes in form and details may be made therein without departing from the spirit and scope of the invention as defined by the appended claims.

1. An electrophotographic image forming apparatus comprising:
a developing unit including a photosensitive medium;
an image transferring device comprising a pair of conveying rollers, a conveying belt supported by the conveying rollers, the conveying belt rotating around the conveying rollers and conveying a recording medium on a surface thereof, and a plurality of transfer rollers disposed inside of the conveying belt, the plurality of transfer rollers forming transfer nips with the photosensitive medium; and
a paper feeding device for providing the recording medium to the image transferring device,
wherein a force of the image transferring device that maintains a position of the recording medium with respect to the conveying belt during image transferring is equal to or greater than the maximum force applied to the recording medium by the paper feeding device.

2. The electrophotographic image forming apparatus of claim 1, wherein the image transferring device further comprises a paper charging roller for electrostatically attaching the recording medium provided by the paper feeding device to a surface of the conveying belt by pressing the recording medium towards the conveying belt and charging the recording medium, wherein the paper charging roller presses the recording medium such that the sum of the maximum static friction force generated by the paper charging roller and the maximum static friction force generated by at least one transfer roller is equal to or greater than the force applied to the recording medium by the paper feeding device.

3. The electrophotographic image forming apparatus of claim 2, wherein the paper charging roller is disposed at a portion where the recording medium enters the image transferring device.

4. The electrophotographic image forming apparatus of claim 3, wherein the plurality of transfer rollers press the recording medium with about the same force, and the paper charging roller presses the recording medium such that the sum of the maximum static friction force generated by the paper charging roller and the maximum static friction force generated by the transfer roller adjacent to the paper charging roller is equal to or greater than the force applied to the recording medium by the paper feeding device.

5. The electrophotographic image forming apparatus of claim 4, wherein the paper feeding device comprises a pair of feeding rollers that rotate while being engaged with each other to feed the recording medium, and the maximum force applied to the recording medium by the paper feeding device is the maximum static friction force between the pair of the feeding rollers and the recording medium.

6. The electrophotographic image forming apparatus of claim 5, wherein the maximum static friction force generated by the paper charging roller is greater than the maximum static friction force between the pair of the feeding rollers and the recording medium.

7. The electrophotographic image forming apparatus of claim 4, wherein the conveying belt is interposed between the conveying roller and the paper charging roller, and the conveying roller and the paper charging roller press each other.

8. The electrophotographic image forming apparatus of claim 1, wherein the paper feeding device comprises a pair of feeding rollers that rotate while being engaged with each other to feed the recording medium, and the maximum force applied to the recording medium by the paper feeding device is the maximum static friction force between the pair of feeding rollers and the recording medium.

9. An electrophotographic image forming apparatus comprising:
a photosensitive medium;
a conveying belt for conveying a recording medium;
at least one transfer roller for forming a transfer nip between at least one transfer roller and the photosensitive medium; and
a paper feeding device for providing a recording medium to the conveying belt,
wherein the force maintaining the position of the recording medium with respect to the conveying belt during image transferring is equal to or greater than the maximum force applied to the recording medium by the paper feeding device.

10. The electrophotographic image forming apparatus of claim 9, further comprising a paper charging roller for delivering the recording medium to a surface of the conveying belt.

11. The electrophotographic image forming apparatus of claim 10, wherein the force maintaining the position of the recording medium with respect to the conveying belt equals fₒ+fₚ, wherein fₒ equals the maximum static friction force applied to the recording medium in the transfer nip and fₚ equals the maximum static friction force applied to paper by the paper charging roller.

12. The electrophotographic image forming apparatus of claim 11, wherein the maximum static friction force fₒ applied to the paper P in the transfer nip equals μₒ×Tₒ, wherein μₒ is the friction coefficient obtained by adding the friction coefficient between the photosensitive medium and the paper to the friction coefficient between the paper and the conveying belt, and Tₒ is a normal force at the first transfer nip.

13. The electrophotographic image forming apparatus of claim 12, wherein the maximum static friction force fₚ generated by the paper charging roller equals μₚ×Tₚ, wherein μₚ is the friction coefficient obtained by adding the friction coefficient between the paper charging roller and the paper to the friction coefficient between the paper and the conveying belt, and Tₚ is a normal force at the paper charging roller.

14. The electrophotographic image forming apparatus of claim 13, wherein the maximum force applied to the recording medium by the paper feeding device equals μᵣ×Tᵣ, wherein μᵣ is the friction coefficient obtained by adding the friction coefficient between the paper feeding roller and the paper to the friction coefficient between the paper and the conveying belt, and Tᵣ is a normal force at the paper feeding roller.

15. An electrophotographic image forming apparatus comprising:
a developing unit including a photosensitive medium;
a conveying belt for conveying a recording medium;
at least one transfer roller for forming a transfer nip with the-photosensitive medium;
a paper feeding device for providing a recording medium to the conveying belt; and
a paper charging roller for attaching the recording medium provided by the paper feeding device to a surface of the conveying belt,
wherein the maximum static friction force generated by the paper charging roller and the maximum static friction force generated by the at least one transfer roller is equal to or greater than the force applied to the recording medium by the paper feeding device.

16. The electrophotographic image forming apparatus of claim 15, wherein the paper charging roller presses the recording medium towards the conveying belt and charges the recording medium.

17. (canceled)

18. The electrostatic image forming apparatus of claim 15, wherein the paper charging roller is disposed opposite one of a pair of conveying rollers.

19. The electrostatic image forming apparatus of claim 18, further comprising means for biasing the paper charging roller toward the conveying roller.

20. The electrophotographic image forming apparatus of claim 15, wherein the paper feeding device comprises a pair of feeding rollers that rotate while being engaged with each other to feed the recording medium, and the maximum force applied to the recording medium by the paper feeding device is the maximum static friction force between the pair of feeding rollers and the recording medium.
